(19) United States
(12) Patent Application Publication
(10) Pub. No.: US 2012/0253887 A1
(43) Pub. Date: Oct. 4, 2012

(54) Methods and System for Obtaining and Using Opinions

(76) Inventors: Peter Lum, Bartonsville, PA (US); Clifford Lum, Bartonsville, PA (US); David Lum, Santa Barbara, CA (US); Tiffany Lum, Bartonsville, PA (US)

(21) Appl. No.: 13/396,619

(22) Filed: Feb. 15, 2012

Related U.S. Application Data
(60) Provisional application No. 61/516,101, filed on Mar. 29, 2011.

(51) Int. Cl. G06Q 30/02

(52) U.S. Cl. 705/7.32

(57) ABSTRACT

The intent of this patent is to provide an electronic based platform for the general public and members of particular groups to share their opinion, make payment toward influencing policies, and provide input to commercial, social, financial, and political groups and influence their actions. Demographic, geographic, and other information may also be cross-referenced to increase the utility of the data and focus questions relevant to the participants. Conceptually, we can have the equivalent a Nielsen® rating not from a few thousand but millions. We can have the equivalent of Election Day every week or every month. We can have a referendum on issues every day. The implication of its effect on society is a democracy come true. The ease of use and the accessibility will make even the true novice in electronic communication devices enthusiastic participants.

The concept identified in the introduction can be implemented in a variety of ways. The method described herein will in no way limit the scope of the patent herein applied. The fundamental of this patent are: (1) the concept of providing a platform for the opinion gathering (2) to make such information useful, as previously described and (3) the method of its implementation, (4) the communication flow for implementing the system, (5) provide rewards to provide incentives to users (6) provide a method for users to pose their own issues, and (7) ability to interact with other groups. The aspects will thus be separately described:
1. The Platform—The Platform described can be applied to any methods of electronic communications such as websites, electronic gaming environment (such Xbox360®, Nintendo® gaming systems, etc), mobile communication device applications (such as Apple®, Microsoft®, and Android® apps). The platform upon which this opinion sharing and use can consist of separate but coexisting segments: (1) A question section where direct issues are posed about any of the mentioned relevant areas with multiple choice answers and/or a comment area for additional inputs. (2) A forum area where relevant topic areas are setup for sharing of opinions, ideas, concepts, and information relating to those specific topics. Over or subcategories can be setup to divide them so as to be more easily identified. An example for instance is to have one issue the “rebellion in Egypt” the overall category may be international politics and the subcategory be ‘resignation of its president”. Questions may also be included in this part for more directed response to the specifics of the issue. For instance, we may ask whether the US should take a role in removing its president from office. (3) A company, political entity, person(s), or organizations specific section may be included. Here the provider of the platform can setup with or without the request of such entity a separate section to address the opinions of the participants as to their products, service, method of operation, social responsibility or other issues of interest.
2. The Usage of the Data—The opinions so obtained may be used to influence the actions of those of which the opinion concerns. An example is if a majority of users thinks a political issue to be too onerous, the results may be communicated to the proper political entity to enact changes to the law. This can equally be applied to commercial companies and their product or service. In certain cases if the participants feel strongly enough, they may direct payment through this forum to the proper political entity or candidate.
3. Methodology—The methodology herein described will be based on mobile applications (for example iPhone® app, iPad® apps, Android® apps, and Microsoft® apps) for simplicity but will be made for other systems (such as games, websites, etc). In this original conceptualization, the user of the app will be asked demographic (such as age, educational level, income level, etc), and geographical (such as zip code of residency) information, email address, or some type of user ID system. Once enrolled, the app stores the information remotely and on the users system. A point system can be added to encourage participation with awards of recognition, prizes and money. Such a point system will reward for participation and/or introducing others to participate. To keep interest high, user may be offer the option of choosing the topic areas in which they have most interest (such as sports, politics, entertainment). Once so chosen, they are directed to pages of questions in which the answers can be multiple choice or degrees of agreement, or ordering of likes, and including a section for verbal comments. The up to date statistical data obtained may or may not be available to the participant at the time of entry. The data is forwarded to a database on a remote system for storage to be analyzed as required. The results may be forwarded to relevant entities such as companies, politicians, and heads of social organizations. Fees may be charged for the data. Participants if so incline can also route directly or through the app contributions to foster the effort of the entity involved. Advertisements may be included to further monetize the app.
4. Implementation—Users will have multiple options for connecting to our platform depending on the capabilities of their device. Devices equipped with Internet browsers can connect to our platform through our web site. The browsers will display the web pages (designed using a combination of HTML, CSS, and JavaScript). Communication between the browser and our servers will utilize a secure HTTPS connection. For devices where native applications (apps) are an option, users can connect to our platform through an app designed specifically for that mobile platform. The language used to develop each mobile app will depend on the platform; these languages include Objective-C and Java. The mobile apps will utilize web service and XML to transfer data to and from the server. Regardless of the connection method, users will be able to post questions, respond to questions and update their information. The servers will include, but are not limited to, a web server and a database server. The webserver, through the use of our PHP files, will handle the traffic from user devices, perform our application logic, and communicate with the database. The database will be the central storage point for all application and platform data. A schematic of this is shown on Figure A.
5. Coupons and financial rewards—Rewards can be sent to the users and a section of the app or web page can show user all the coupons available to them. In addition payments or entry into a cash drawing will add incentive for participation. A point system based upon reply to the questions/issue and recommending others to participate can be used to make award these rewards.
6. Posting users own issues—Aside from just getting info obtained through the site, individuals, groups, companies and other entities can set up their own query through this platform to address their own need for information. This would allow them to direct their query to the large user pool available through this platform.
7. Interaction with other Groups—Users may setup their own Q&A and link this with other sites and social networking groups to obtain even greater interaction and utility.

### BRIEF DESCRIPTION OF FIGURES

The figures provided represent sample screen displays.

FIG. 1. This is the opening page for participants to sign in to access the platform. Participants enter their info so that a membership number is assigned but may not be visible to the participant. The info provided here is stored remotely together with the membership number so that this data cannot be stolen if the mobile device or computer is loss. The info herein contained will be used to forward rewards and potentially to correlate the opinions with the geographic and demographic data.

FIG. 2. Once the participant has registered as a member this page allows them to navigate to the screen they want. The setting choice allows the user to change their profile (see FIG. 3). Their points gained so far is also displayed. The company code relates to codes provided by companies that request members to input their opinions. Choosing this option gets the member to a list of issues specific to that company (see FIG. 4). Members can also join a specific forum to offer opinions in specific general areas (see FIG. 5). The Question and Answer choice directs the members to a list of questions generated by the Host company (Owner of the Platform) (see FIG. 8). Choosing coupons allows the user to see all the coupons that the participating companies have issued to the member (see FIG. 9). Users can also introduce their own set of questions to be addressed to other members (see FIG. 11).

FIG. 3. This page displays the information provided by the user and allows them to change them.

FIG. 4. This is a sample question posed by a participating company.

FIG. 5. This page offers users the category of forum they would like to join.

FIG. 6. This shows some sample topics under the politics forum category.

FIG. 7. A sample screen for the Flat Tax forum.

FIG. 8. This is a representative screen of issues posed by the Host.

FIG. 9. This is the screen showing the companies that the have issued coupons to the member.

FIG. 10. This is a sample coupon.

FIG. 11. This page allows companies and members to pose their own Q&A.

FIG. 11a. This page follows FIG. 11 used to set up the questions.

FIG. 12. This allows the user to put their questions in other social networking site.

FIG. 13. The user can display results of the Q&A in a site.

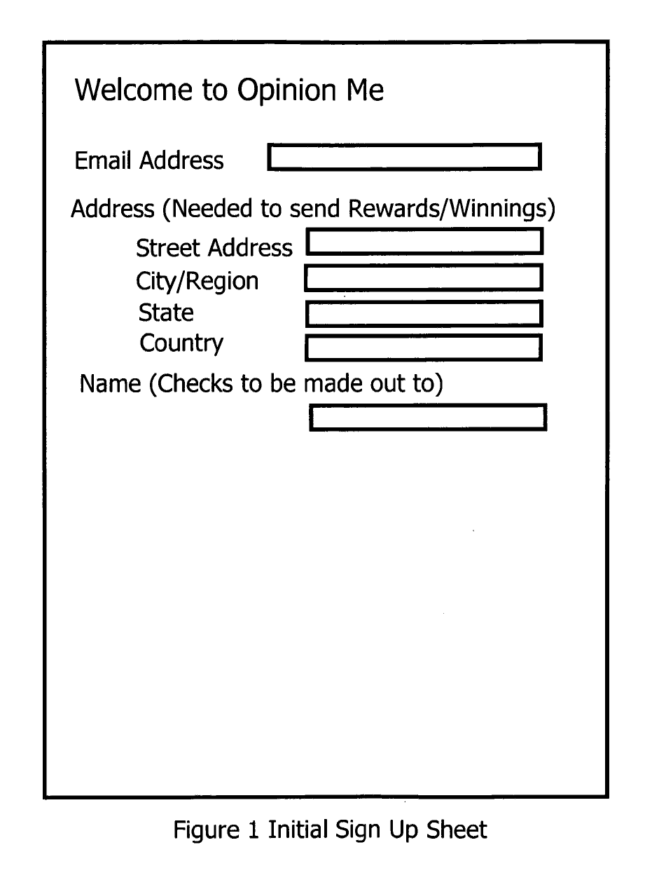

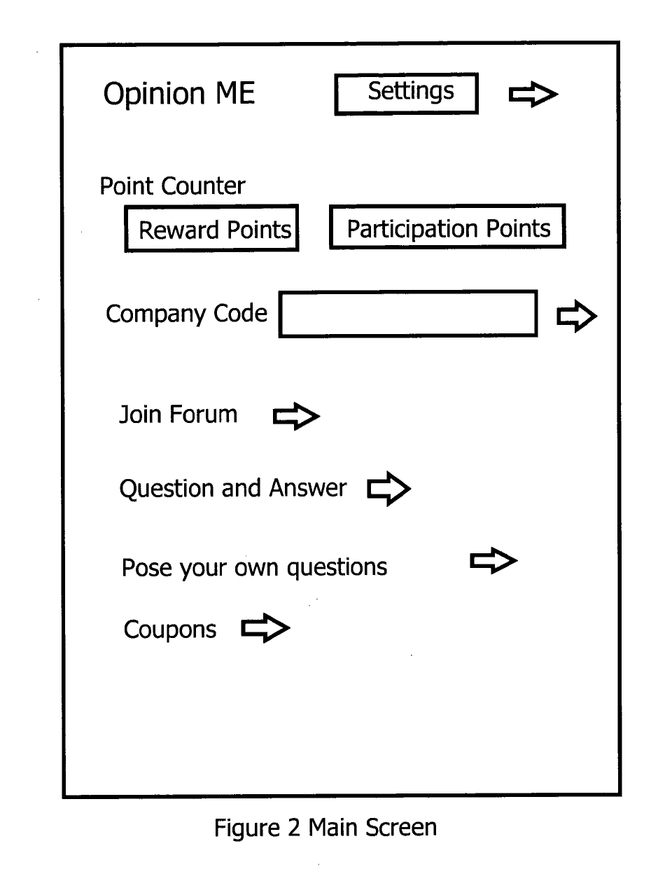

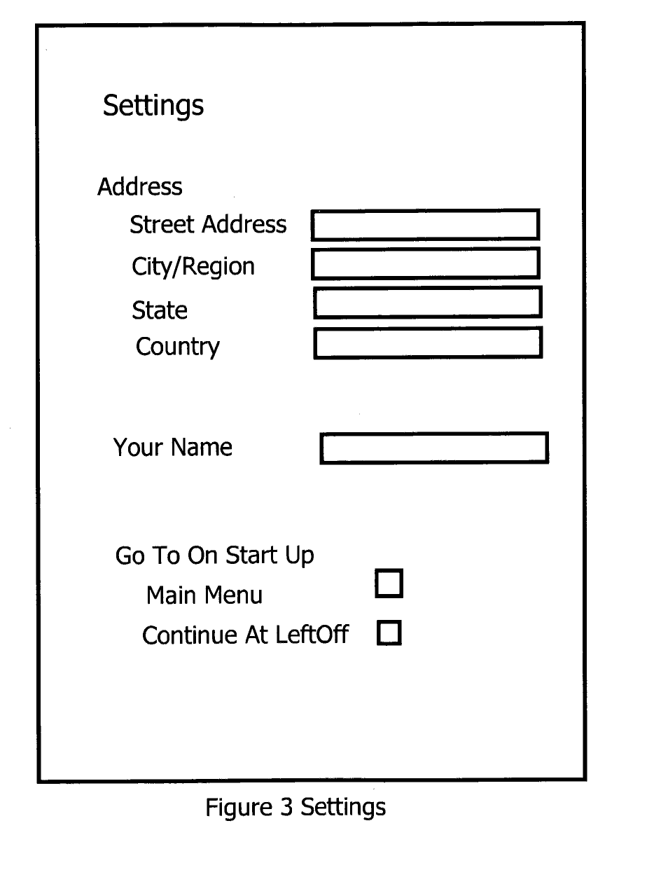

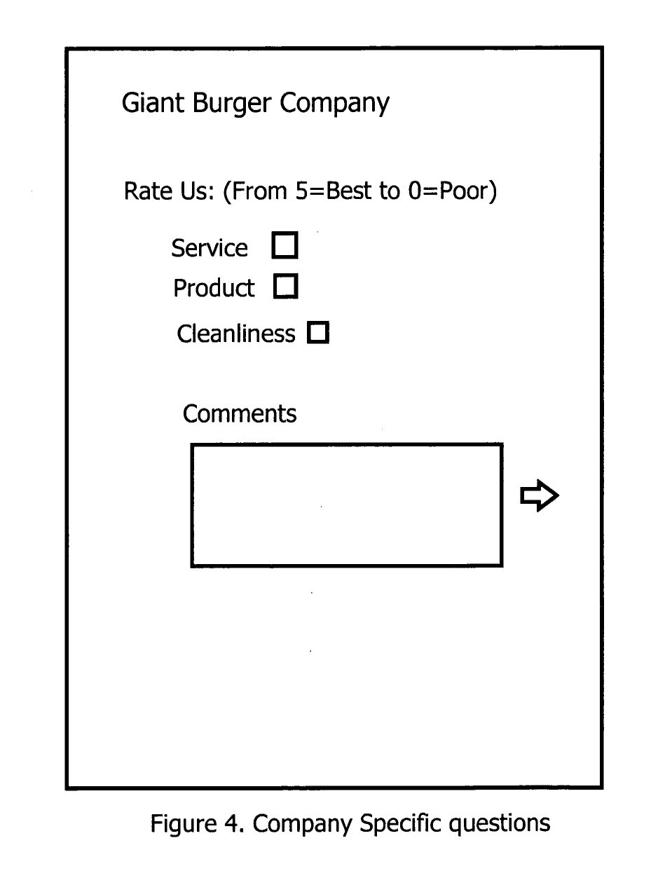

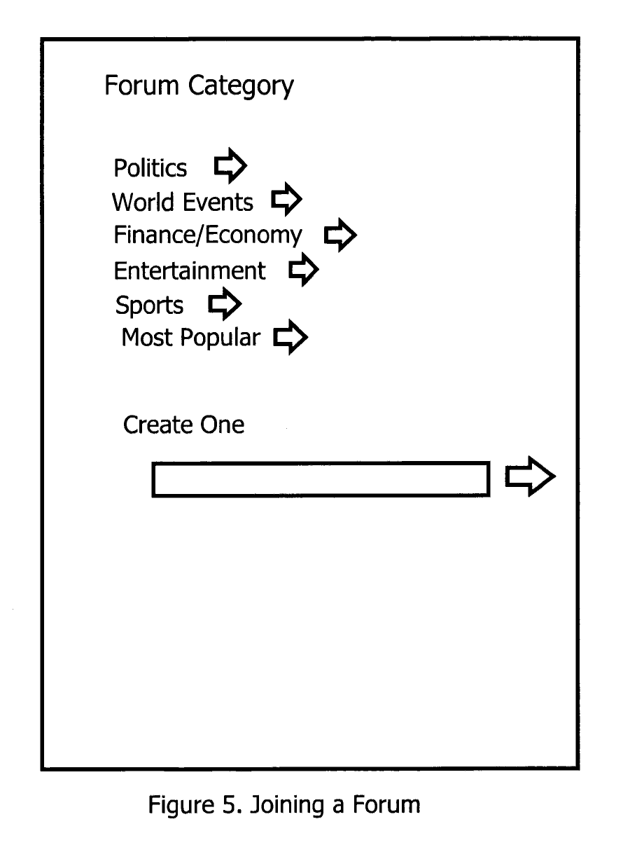

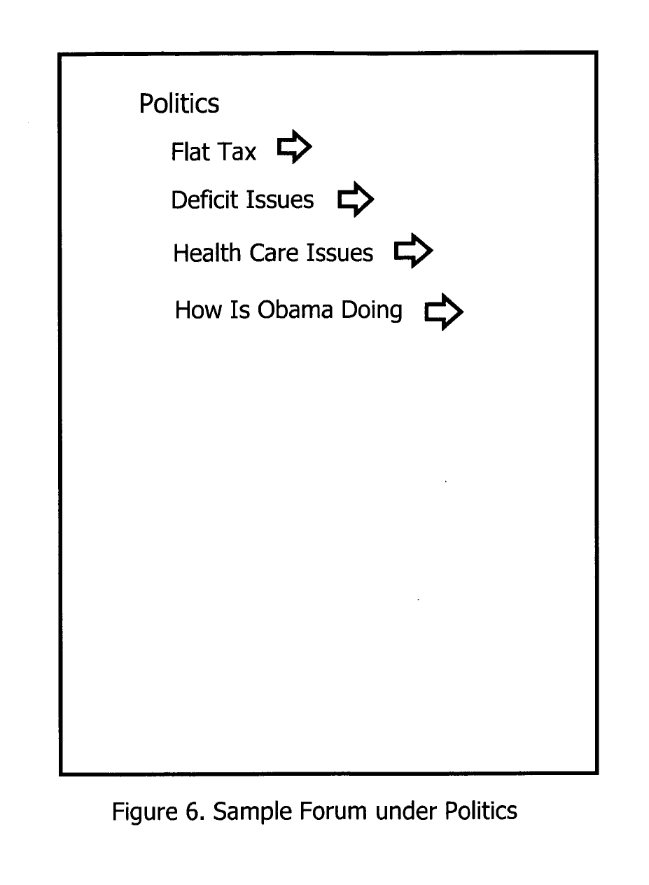

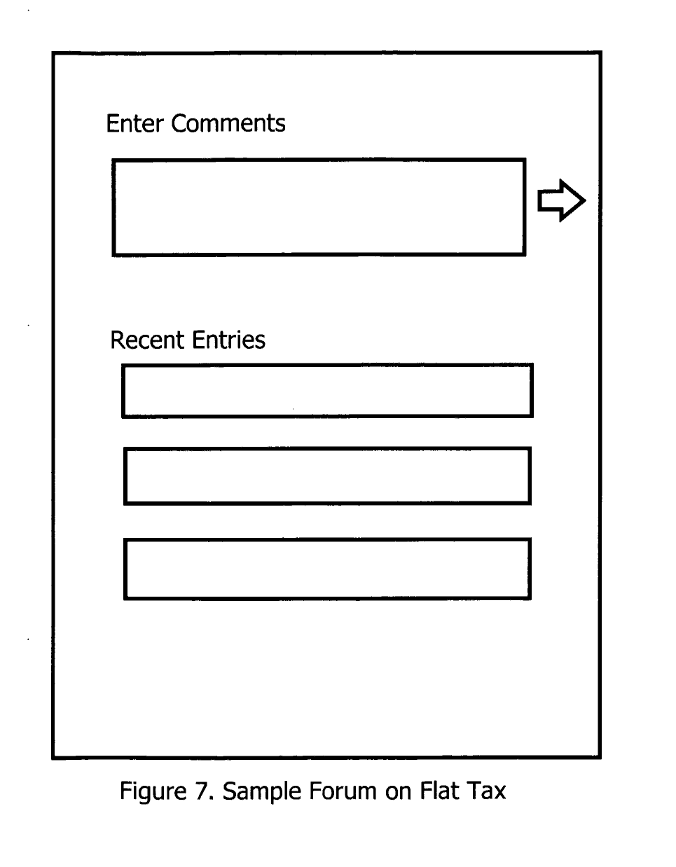

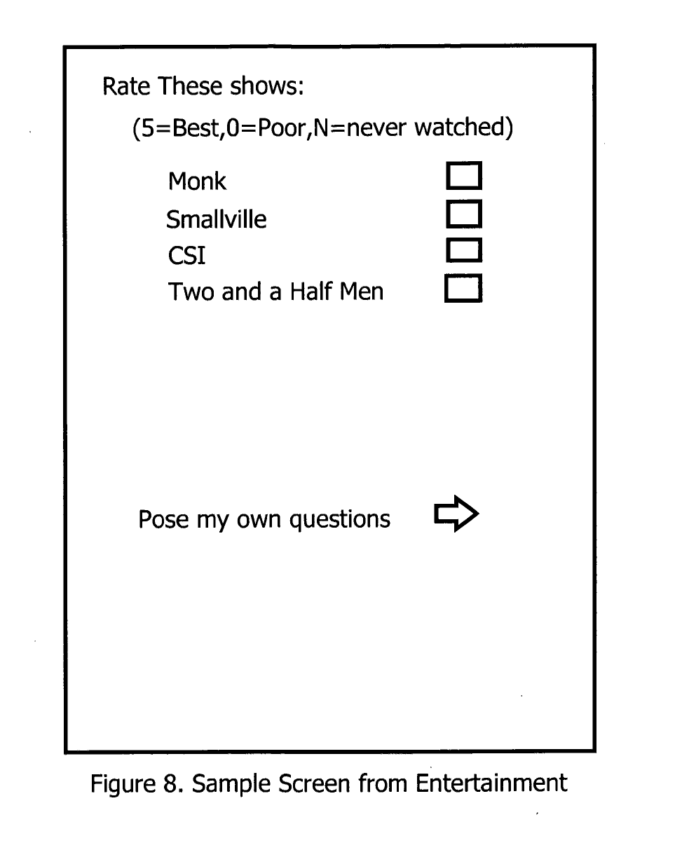

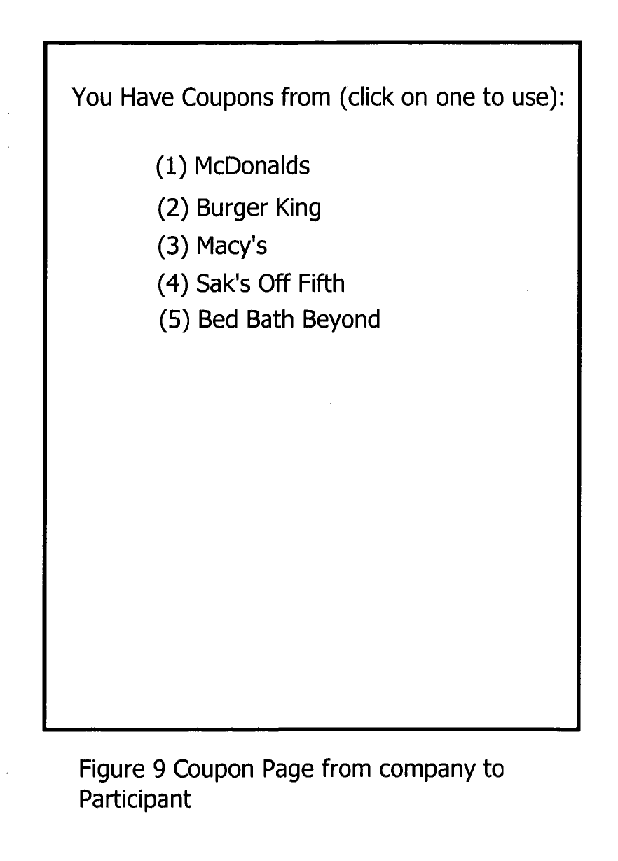

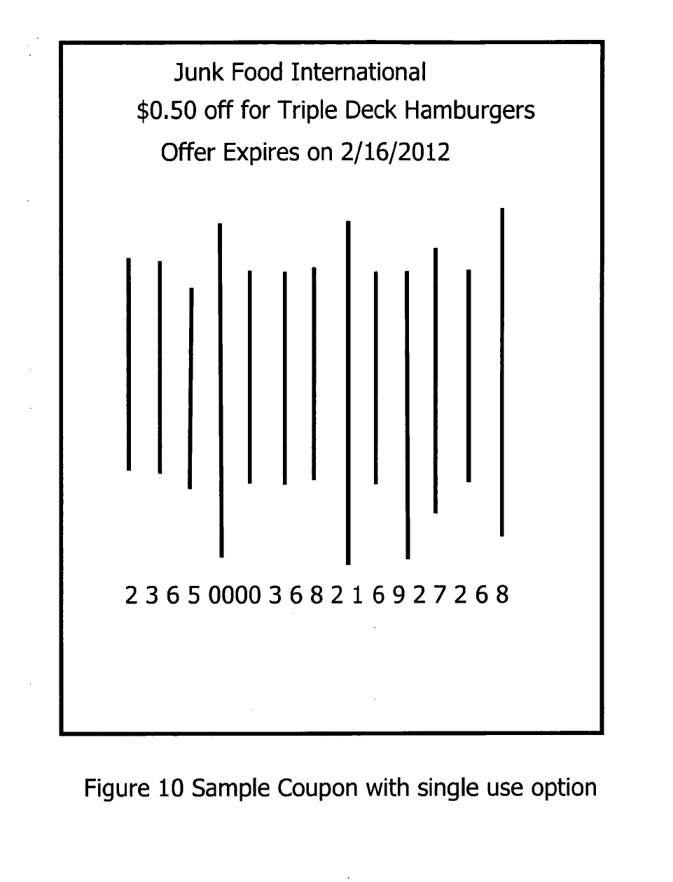

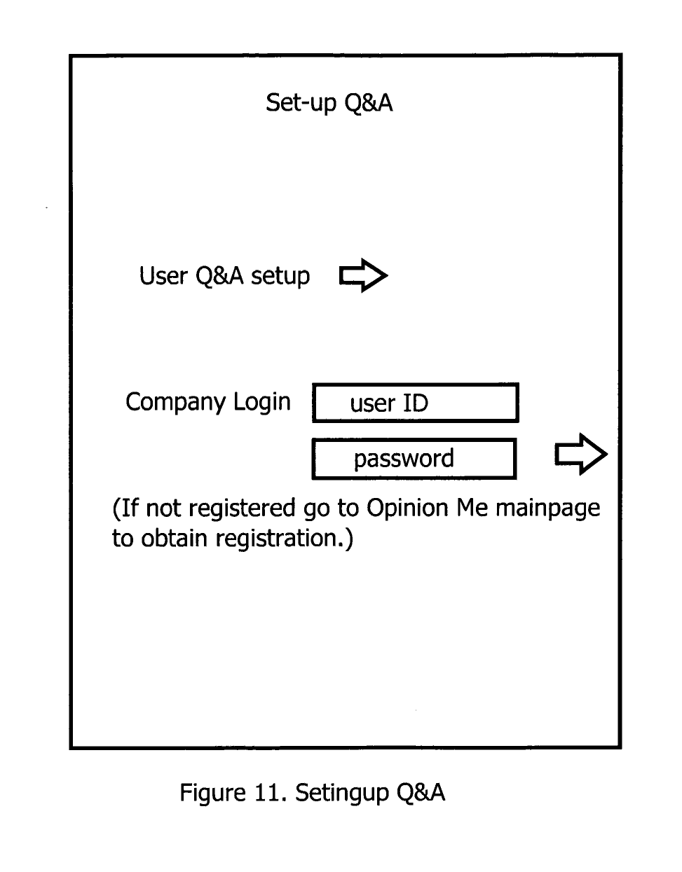

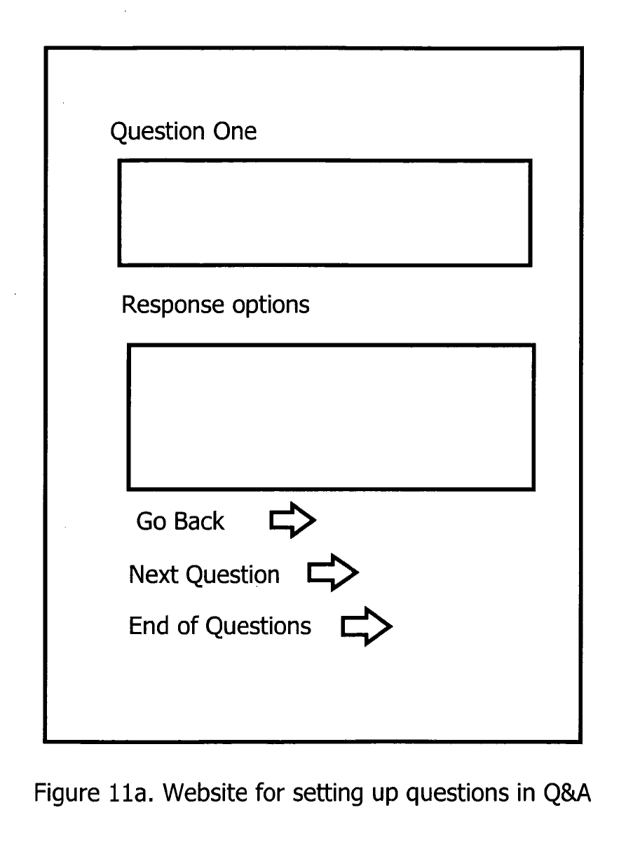

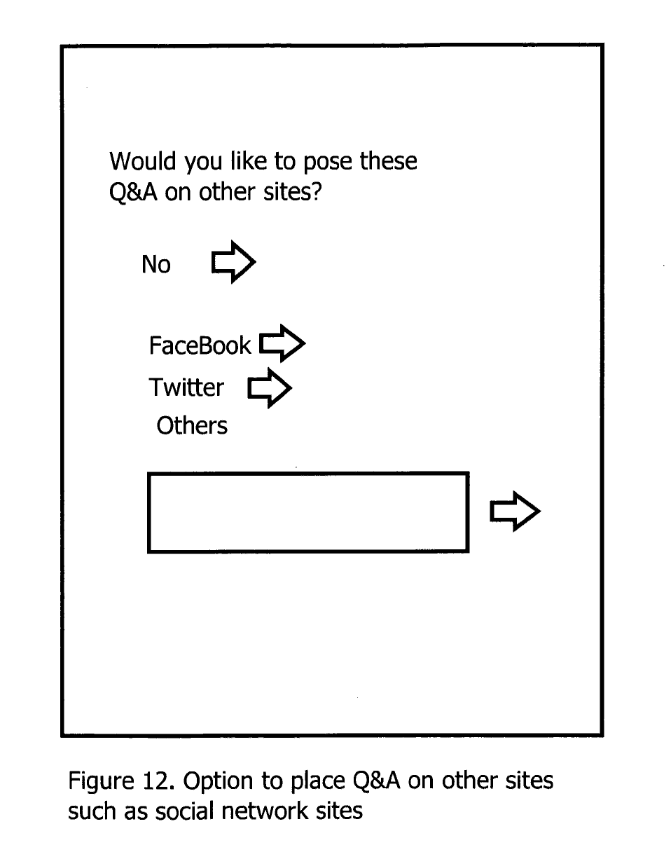

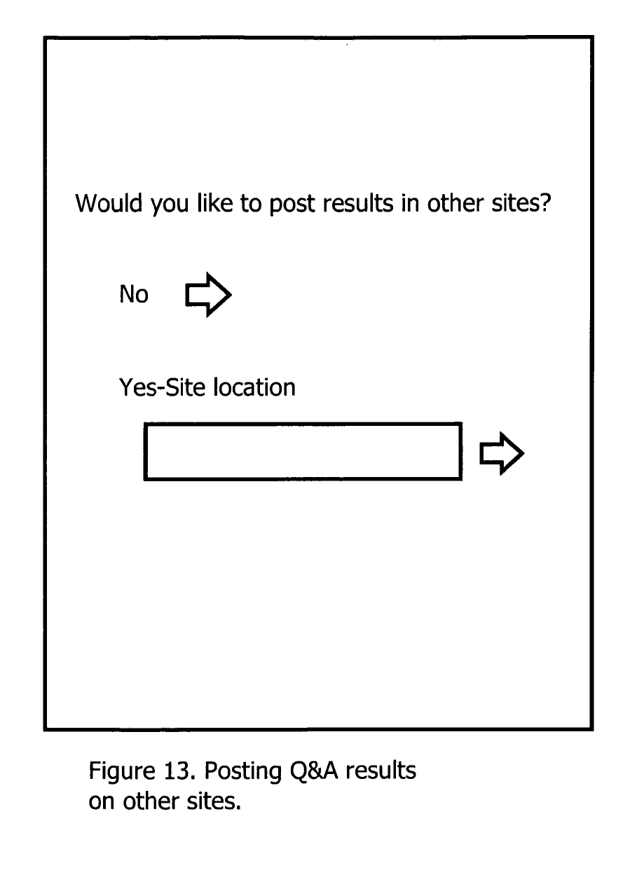

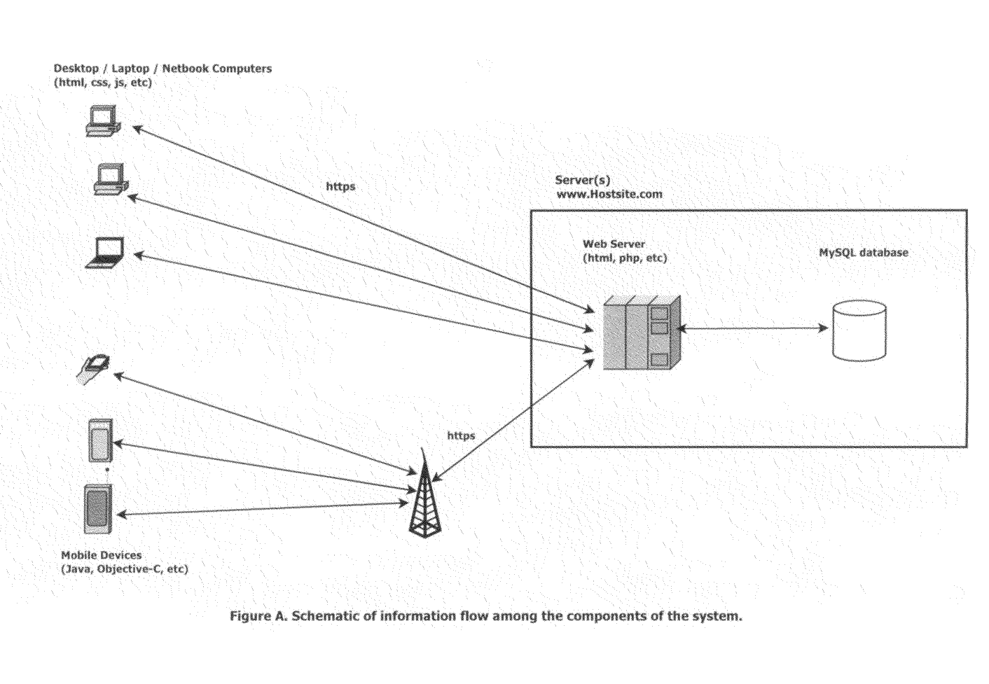

Figure A. Is a schematic of the interaction between the users, the server and Host file system used in the implementation of the platform of this patent.

The invention claims are:

1. A method for posting web page, any interactive mobile device or computer, a gaming console system, or any interactive electronic device for inducing participants to enter their opinions on a variety of subjects. Such subjects can include political, financial, business, entertainment, commercial, and social issues.

2. The method of claim 1 provides for setting up of a platform for entry of such opinions on subjects, issues and questions posted by the Host system or by its participants.

3. The method of claim 1, can provide for Inducements in the form of prizes, coupons, and monetary and non-monetary awards.

4. The method of claim 1, demographic, geographic, or other differentiating factor information may also be requested so as to obtain breakdown of opinions and data by such criterions. Such differentiation can also be used so as to pose differing subsequent questions and issues to them.

5. The method of claim 1, a separate section can be made to address issues specific to an entity, be they a person, a company, an organization, or a governing body.

6. The method of claim 1, the method can also include the sending of advertisement as part of the display.

7. The method of claim 1, questions may take many forms including yes/no, degree of agreement, and ordering a list.

8. The method of claim 1, since information had been obtained about the participants, target questions and advertising may be delivered with or without permission of the participants even though the present concept is to have approval of the participants.

9. The method of claim 1, inputs from this methodology may be used to improve lives through changing or directing direction of political decisions, which show goes on TV and video, what movies get made, what decisions are made by political, social and commercial entities.

10. The method of claim 1, fund raising by political, social (such as charities and non-profit organization), and commercial enterprises can also be used under this methodology.

11. The method of claim 1, the questions or issues posed may be sequenced so that they depend on the prior response.

12. The method of claim 1, participants and users can pose their own issues or questions for opinions.

13. The method to claim 1, the questions and its results can be linked to the hosting site and other sites such as websites, social sites, and proprietary sites or mobile device apps.
